(19) United States
(12) Patent Application Publication
(10) Pub. No.: US 2014/0370966 A1
(43) Pub. Date: Dec. 18, 2014

(54) ONLINE FANTASY SPORTS GAME SYSTEM AND METHOD

(71) Applicant: HOTBOX SPORTS LLC, Haworth, NJ (US)

(72) Inventor: Tarek BAHOU, Haworth, NJ (US)

(21) Appl. No.: 13/918,652

(22) Filed: Jun. 14, 2013

(51) Int. Cl. G07F 17/32

(52) U.S. Cl. CPC G07F 17/3225
USPC 463/25; 463/42; 463/31

(57) ABSTRACT

Computer-implemented methods are provided for enabling a user to play an online fantasy sports game system on a network-connected device Related systems for enabling a user to play an online fantasy sports game system on a network-connected device are also provided, along with a non-transitory computer readable media for executing the methods.

### TECHNICAL FIELD

The present invention relates to fantasy sports, and the software used in a preferred embodiment, having a game submission feature that allows a user to select one or more real-life players and for which real-life statistics generated by each player during selected real-life games are used to determine if the user is a winner based on the user's selection of the best performer from a roster of players in multiple selected tiers.

### BACKGROUND

Fantasy sports is a game where participants act as owners to build a team that competes against other fantasy owners based on the statistics generated by the real individual players or teams of a sport. Usually statistical performances are converted into points that are compiled and totaled according to a roster selected by a manager (or owner) that makes up a fantasy team. More complex variants use computer modeling of actual games based on statistical input generated by professional sports. In fantasy sports there is sometimes the ability to trade, cut, and sign players, like a real sports owner. A typical fantasy sport league can require a large time commitment for at least an entire season and can also require a large amount of work to do research about teams and players. Improvements to the game and its application to new areas can increase the interest and its excitement in the game. Such improvements are disclosed and described by co-owned U.S. Ser. No. 13/741,245 for an ONLINE FANTASY SPORTS GAME SYSTEM AND METHOD, filed Jan. 14, 2013 and incorporated by reference herein in its entirety.

Additional improvements and challenges as disclosed herein further escalate interest and participation in such games.

### SUMMARY

A method is directed towards enabling a user to play an online fantasy sports game over a network-connected device . The method may include, on the network-connected device, presenting at least one user with an opportunity to play the online fantasy sports game when the user lands on a lottery site. In response to a user selection to play the fantasy sports game on the lottery site, the user may be directed to the online fantasy sports game. In response to the selection to play the fantasy sports game, the user may be provided with a plurality of fantasy sports selection options for playing the fantasy sports game. The plurality of fantasy sports selection options may include at least one option to select one or more tiers with each selected tier including a roster of real-life players established within the selected tier, and at least one option to select, within each selected tier, a real-life player predicted by the user to have a real-life performance superior to other players within the selected tier during at least one upcoming game of American football. The real-life players are listed for selection in association with the individual real-life players' upcoming game in a common week of a football season. One or more fantasy sports selections may be received from the user that completes a lottery submission before the upcoming game begins. Each fantasy sports selection includes at least one selected tier and a player selected within the selected tier, with the user submitting multiple fantasy sports selections from multiple tiers. On a computer system and from a data feed of game activity, a fantasy performance score may be generated for each selected player and for each unselected player within each selected tier. The fantasy performance score for each selected player and each unselected player within each tier can be compared, and a highest fantasy performance score attributable to each player within the selected tier can be determined. On the computer system, user that have won the online fantasy sports game can be determined based on each user's selections and each of the determined corresponding fantasy performance scores. Determine whether a user has won includes determining the user is a winner when each of the user's multiple selections match a real-life performance for each real-life player. A notification may be generated that notifies one or more winners of corresponding lottery submissions when one or more users are identified by the computer system to have won the fantasy sports game.

The method may further include blocking a user from altering the lottery submission after receiving, from the user, the fantasy sports selections, Blocking the user may include at least one of preventing the user from selecting more than one real-life player within any selected tier, and preventing the user from selecting any real-life player in more than one tier.

In embodiments of the presently disclosed method, the one or more related actual sports games includes professional football teams, semi-professional football teams and college football teams.

The method may further include determining, on a computer system, an award amount for each game submission. A multiplier selection may be provided that, when selected and the user is a winner, increases an award to the user.

In some embodiments, at least one of the online fantasy sports game and the lottery site is a mobile application.

In another embodiment of a method that enables a user to play an online fantasy sports game on a network-connected device, a display on the network-connected device is provided on which at least one tier of real-life players established within the selected tier is displayed as participating in at least one upcoming real life sporting event. A user may be enables to make a selection to play the fantasy sports game. The user may provided a plurality of fantasy sports selection options for playing the fantasy sports game, with the plurality of fantasy sports selection options including at least one option to select one or more tiers with each selected tier including a roster of real-life players established within the selected tier, and at least one option to select, within each selected tier, a real-life player predicted by the user to have a real-life performance superior to other players within the selected tier superior to other players within the selected tier during at least one upcoming game of American football. The real-life players are listed for selection in association with the individual real-life players' upcoming game in a common week of a football season. A computer system may receive one or more fantasy sports selections that completes a lottery submission before the upcoming game. Each fantasy sports selection can include at least one selected tier and a player selected within the selected tier, with the user submitting multiple fantasy sports selections from multiple tiers. On the computer system using data feeds of game activity, a fantasy performance score can be generated for each real life player corresponding to a roster of players within each selected tier using a fantasy scoring formulation. A highest fantasy performance score attributable to each player within the selected tier can be determined, and the fantasy performance score for each selected player and each unselected player within each tier can be compared. On the computer system, users that have won the online fantasy sports game can be determined based on each user's selections and each of the determined corresponding fantasy performance scores. Determining users who have won may include determining the user is a winner when each of the user's multiple selections matches a real-life performance for each real-life player. A notification may be generated that notifies one or more winners of corresponding lottery submissions when one or more users are identified by the computer system to have won the fantasy sports game.

At least one system is also provided for enabling a user to play an online fantasy sports game system on a network-connected device. The system includes at least one server configured to perform actions comprising accessing the system over a network and performing at least one of the presently disclosed methods.

At least one non-transitory computer-readable media is also provided having a plurality of instructions that, when executed, cause a network-connected device to perform at least one of the presently disclosed methods.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 shows an example of a computing environment in which embodiments of the presently disclosed system and method may be implemented;

FIG. 2 shows an example of a communication system for use with the computer system of FIG. 1;

FIG. 3 shows an example of a fantasy sports game process;

FIG. 4 shows illustrates an exemplary system within which the process of FIG. 3 may be executed;

FIG. 5 shows an example of a selection page used to review and submit selections within a fantasy sports game;

FIG. 6 shows an example of a game viewing page used to review upcoming games and any associated data and media; and FIG. 7 shows another example of a fantasy sports game process.

### DETAILED DESCRIPTION

In accordance with some principles of the present invention, an online fantasy sports game system and method of playing that allows a user to make selections, such as professional teams, players, specific games, etc., and potentially win an award if the selections made are correct can be provided.

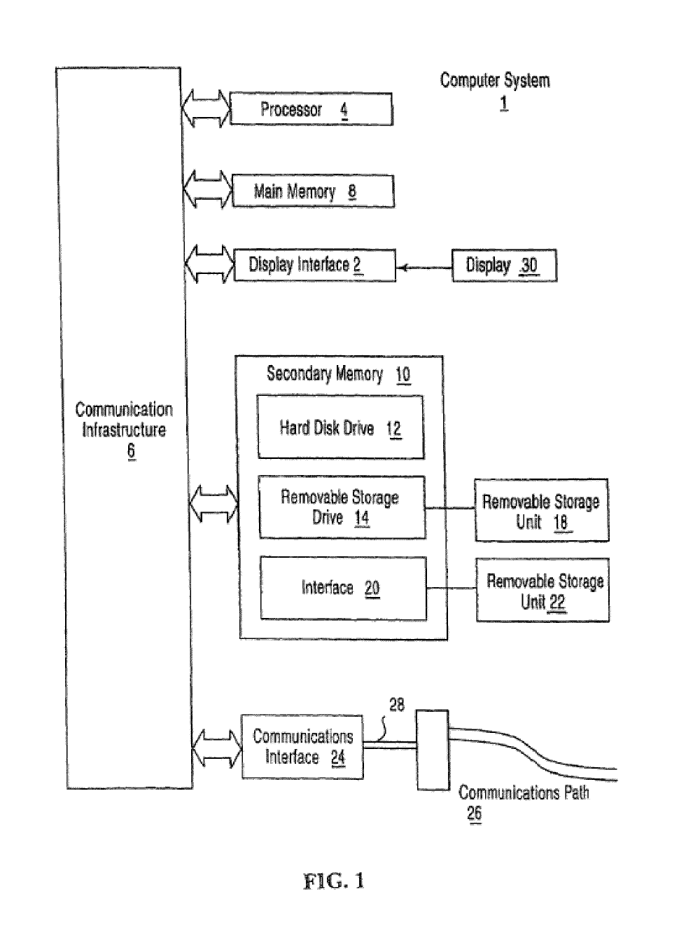

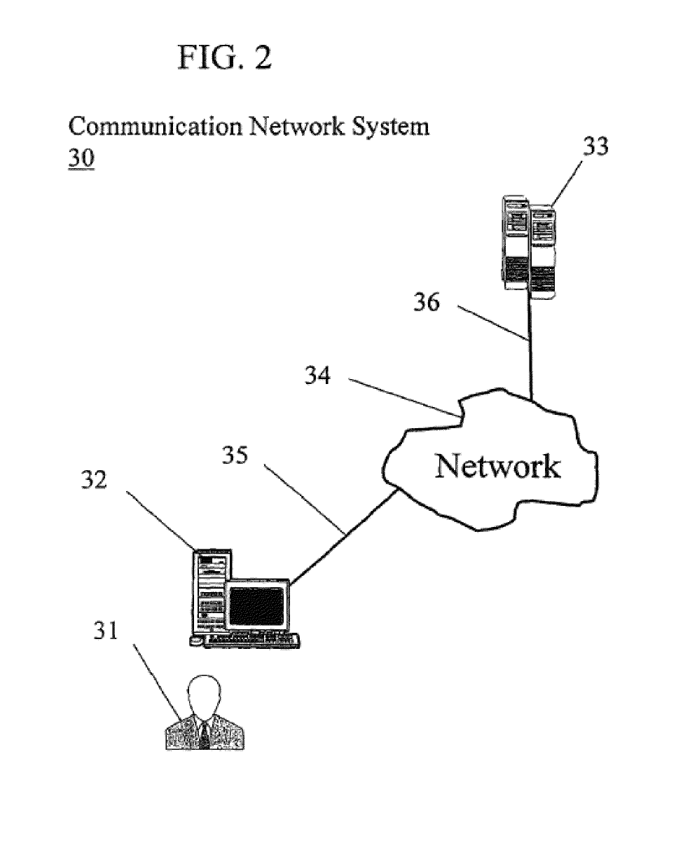

As shown in FIG. 1, the present invention may be implemented using hardware, software, or a combination thereof, and may be implemented in one or more computer systems or other processing systems, In one embodiment, the invention is directed toward one or more computer systems capable of carrying out the functionality described herein.

FIG. 1 shows a computer system 1 that includes one or more processors, such as processor 4. The processor 4 is connected to a communication infrastructure 6 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 1 can include a display interface 2 that forwards graphics, text, and other data from the communication infrastructure 6 (or from a frame buffer not shown) for display on the display unit 30. Computer system 1 also includes a main memory 8, preferably random access memory (RAM), and may also include a secondary memory 10. The secondary memory 10 may include, for example, a hard disk drive 12 and/or a removable storage drive 14, representing a floppy disk drive, a magnetic tape drive, an optical disk drive, etc. The removable storage drive 14 reads from and/or writes to a removable storage unit 18 in a well known manner. Removable storage unit 18, represents a floppy disk, magnetic tape, optical disk, etc., which is read by and written to removable storage drive 14. As will be appreciated, the removable storage unit 18 includes a computer usable storage medium having stored therein computer software and/or data.

In alternative embodiments, secondary memory may include other similar devices for allowing computer programs or other instructions to be loaded into computer system 1. Such devices may include, for example, a removable storage unit 22 and an interface 20. Examples of such may include a program cartridge and cartridge interface (such as that found in video game devices), a removable memory chip (such as an erasable programmable read only memory (EPROM), or programmable read only memory (PROM)) and associated socket, and other removable storage units 22 and interfaces 20, which allow software and data to be transferred from the removable storage unit 22 to computer system 1.

Computer system 1 may also include a communications interface 24. Communications interface 24 allows software and data to be transferred between computer system 1 and external devices. Examples of communications interface 24 may include a modem, a network interface (such as an Ethernet card), a communications port, a Personal Computer Memory Card International Association (PCMCIA) slot and card, etc. Software and data transferred via communications interface 24 are in the form of signals 28, which may be electronic, electromagnetic, optical or other signals capable of being received by communications interface 24. These signals 28 are provided to communications interface 24 via a communications path (e.g., channel) 26. This path 26 carries signals 28 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 14, a hard disk installed in hard disk drive 12, and signals 28. These computer program products provide software to the computer system 1.

Computer programs (also referred to as computer control logic) are stored in main memory 8 and/or secondary memory 10. Computer programs may also be received via communications interface 24. Such computer programs, when executed, enable the computer system 1 to perform the features of the present invention, as discussed herein. In particular, the computer programs, when executed, enable the processor 4 to perform the features of the present invention. Accordingly, such computer programs represent controllers of the computer system 1.

In an embodiment where the invention is implemented using software, the software may be stored in a computer program product and loaded into computer system I using removable storage drive 14, hard drive 12, or communications interface 24. The control logic (software), when executed by the processor 4, causes the processor 4 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s). In yet another embodiment, the invention is implemented using a combination of both hardware and software. It is understood that the exemplary environment illustrated in FIG. 1 is not intended to limit the present disclosure, and that other alternative hardware and/or software environments may be used without departing from the scope of this disclosure.

Now referring to FIG, 2, which is a communication system for use with the computer system of FIG. 1, in accordance with one embodiment of the present invention. The communication system 30 includes an accessor 31 (also referred to interchangeably herein as a “user”) and a terminal 32. In one embodiment, data for use in the computer system 1 is, for example, input and/or accessed by the accessor 31 via the terminal 32, such as a personal computer (P( ) minicomputer, mainframe computer, microcomputer, telephonic device, or wireless device, such as a hand-held wireless device coupled to a server 33, such as a PC, minicomputer, mainframe computer, microcomputer, or other device having a processor and a repository for data and/or connection to a processor and/or repository for data, via, for example, a network 34, such as the Internet or an intranet, and couplings 35, 36. The couplings 35, 36 include, for example, wired, wireless, or fiberoptic links. In another embodiment, the method and system of the present invention operate in a stand-alone environment, such as on a single terminal. For all data received or transmitted under the present invention, such as player statistics and team scores, may be calculated based on values input, which may be manually input or downloaded from a database at any location, preferably remote. The database itself can be online, stored in fixed memory, or disk-based.

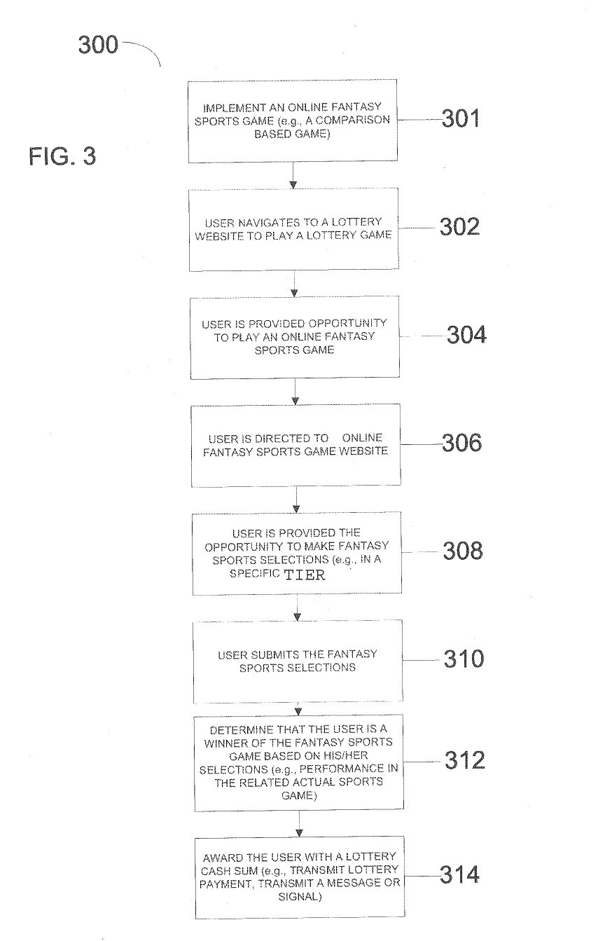

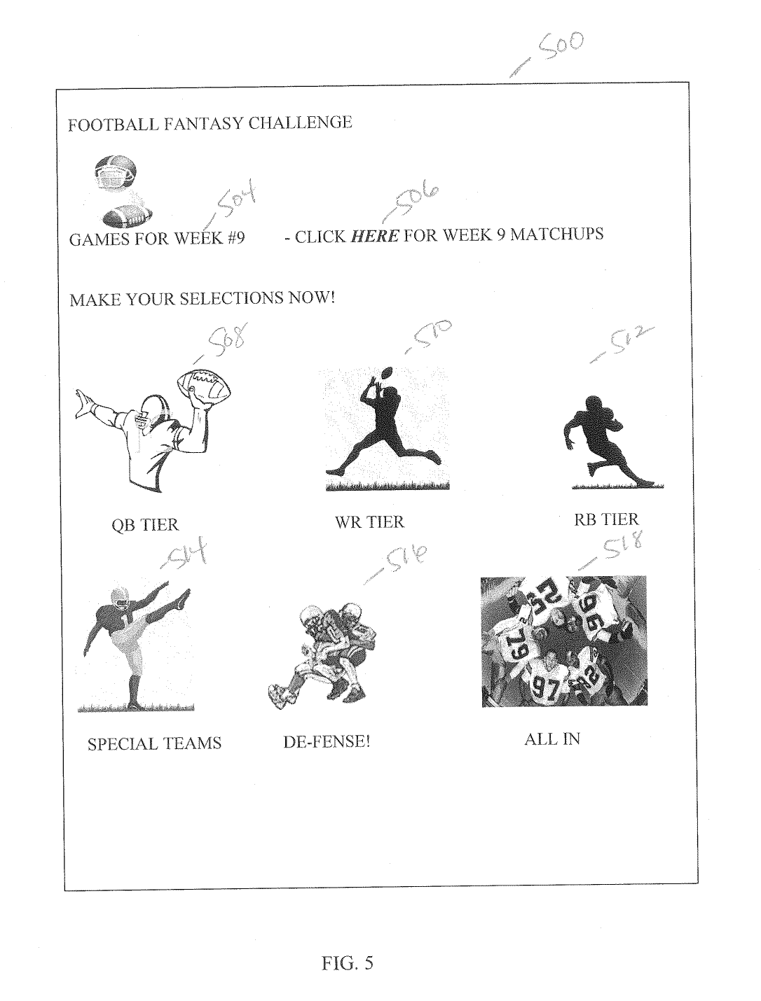

Now referring to FIG. 3, an exemplary method 300 starts when a user accesses an online fantasy sports game system at step 301. At step 301, an online fantasy sports game cr., a comparison based game) is implemented in which each user is a “fantasy player” in connection with one or more real life sports games. The user may access the online fantasy sports game system via a network user interface (UI) such as selection page 500 as shown and described with respect to FIG. 5. A log-in feature may be presented on a login page (not shown) for the online fantasy sports game system. In some embodiments utilizing a log-in page, a log-in may not be immediately presented but may be accessible from another web page or from a mobile application. in such embodiments utilizing a log-in page, the user may submit login credentials via the login page, although in alternative embodiments, this step may performed by software, such as a script that enters the login credentials when the login page is presented.

At step 302, a user navigates to a lottery site to play a lottery game. Examples of a lottery site include, but are not limited to, nylottery.org, Powerball, Mega Million, Pick 5, etc. It should also be appreciated that the lottery site could be a lottery mobile application downloaded to a mobile device.

At step 304, the user is provided the opportunity to play an online fantasy sports game. The lottery site may include a link or some other method to navigate to an online fantasy sports game. In one embodiment, the lottery mobile application or site may enable a user to play the online fantasy sports game through the application/site. The lottery mobile application/site may also direct the user to download a different mobile application that is directed towards the online fantasy sports game. The lottery mobile application or site may also enable the fantasy player or user to go back and check on the performance of his or her fantasy team or lineup during any time window. The online fantasy sports game may provide this functionality, as well.

At step 306, the user is directed to an online fantasy sports game. The online fantasy sports game may be presented to the user in many different ways including, but not limited to, a website, mobile application and a gaming kiosk. In one embodiment, the lottery site may present the online fantasy sports game within a frame directly on the lottery site.

At step 308, the user is provided the opportunity to make fantasy sports selections (e.g., in a specific time window), A game submission or time window may be a specific time period that is less than a full sports season. For example, if the user selects NFL and then selects Kickoff Weekend (Week #1) for the upcoming season, the user may be presented with all of the actual NFL players (including special teams players) currently on the rosters of the 32 NFL teams. A specific time window may be a designated set of games that will be played for Week #1. Alternatively, a specific set of games may be designated that will be played in a conference and/or division, or a designated set of games played between certain sets of teams. A time window or season subset for a game submission may include just one set of games played in any given time period (e.g., all NFL games played in Week #1). A season subset may also include consecutively or non-consecutively played games. For example, the specific season subset may be all Thursday night, Sunday day, Sunday night and Monday night games scheduled for the NFL teams for a specific week of play.

In the NFL example, the time window may be any subset of games within a 16-week regular season. In the following example, a time window (or season “subset”) may be the set of games played by all NEC East rivals, with the sample Sunday night and Monday Night games being considered as “Week #1” games:

### Season Subset 1: NFC Rivalries

Week 1: PHL at WSH (Monday Night game)
NYG at DAL (Sunday Night game)

Week 5: PIM at NYG

Week 6: WSH at DAL

Week 7: DAL at PHIL

Week 8: NYG at PHI

Week 11: WSH at PHL

Week 12: DAL at NYG

Week 13: NYG at WSH

Week 16: DAL at WSH

Week 17: PHL at DAL
WSH at NYG

The user can therefore select from this list to research and identify players that the user wants to select in each tier.

At step 308, the fantasy player selects a real life game in which tiers of athletes playing the real life games are presented for selection by the user. Each tier may be representative of an actual player position (e.g., for the NFL, there may be a quarterbacks tier, a running backs tier, a defensive linesmen tier, a special teams tier, etc.). Each tier may be representative of an actual player performing at a certain performance level in an actual player position. in an example where the user selects actual players from tiers within the NFL, a tier may be presented that includes all quarterbacks having an established passer rating. An alternative tier may be presented that includes defensive linesman having an established number of sacks, while another alternative tier may be presented that includes all kickers having an established parameter for points after touchdown. Other alternative tiers are contemplated, including but not limited to rookie and sophomore players (e.g., the performance of Andrew Luck as a sophomore quarterback may be compared to the performances of other sophomore quarterbacks, other sophomore players in other positions, other quarterbacks from Andrew Luck's draft class or other players from Andrew Luck's draft class in other positions). Such features make the online sports game more challenging for participants and encourages multiple selections within multiple tiers for optimal engagement.

Also at step 308, the user selects one player from an available roster of actual players named within a tier of players for a particular real life game or set of games. In an exemplary embodiment, the user selects one player in at least one tier to have an actual in-game performance surpassing the performance of other players within the same tier. Using the above NFL example, the user may be presented with tiers of quarterbacks, running backs, wide receivers, tight ends, defensive ends, cornerbacks, strong and free safeties, kickers, etc. In Week #1, the user may select Joe Flacco in the quarterback tier as the “Best Performer” in the quarterback tier. Joe Flacco is presented in the quarterback tier along with a roster of other available real life quarterbacks (e.g., Tom Brady, Peyton Manning, Colin Kaepernick, etc.). “Best Performer” status may be established by one or more statistics attributable to the actual player's performance in the selected game (with the understanding that the selected game may be a game played as one game within a season subset of games). For the quarterback tier, statistics that contribute to an actual player being the “Best Performer” may include completion percentage, average yards per attempt, percentage of touchdown passes and percentage of interceptions.

The identification of a “Best Performer” within at least one tier enables the fantasy sports game to dynamically create additional tiers within which a roster of real life players is made available for selection. For example, a single tier may combine actual players from a variety of player positions. In the NFL example given above, Tier 1 may include the top players from all positions in a previous game. As an example, the roster of players available for selection in Tier 1 for Week #8 of a regularly NFL season may include each player that was the “Best Performer” within an assigned tier during Week #7. Tier 1 for Week #8 could therefore include the “Best Performer” from the quarterback tier, the running backs tier and any other tier established during Week #7. Tier 2 may be similarly categorized up to Tier N. In some embodiments, whether an actual player appears in a roster for Tier 1 or Tier N provides no indication of whether that actual player's performance was the “best”. That is, a player in Tier 1 for any given week may not have been the “Best Performer” for any other week, such that previous “Best Performers” may be in a tier roster with players that have not been “Best Performers” for any given game regardless of the positions played by respective players within a common tier roster. The incorporation of different player positions within a single tier may incorporate normalization of player performance among different positions to that presentation of a player roster within a given tier provides a selection of players, at least one of which may be reasonably selected to potentially be a “Best Performer” for an upcoming game.

The fantasy sports game may give the option of selecting one actual player from only a limited number of players within a tier. For example, within a running backs tier, Adrian Peterson may not be available on the roster of selectable running backs who are playing in games within Week #5. This may occur if Adrian Peterson's team has the “bye” for Week #5 (e.g., his team has the week off) or even if Adrian Peterson is playing in a real-life game during Week #5. The user therefore must select real-life player from within the available roster of actual players named within a tier of players for a particular real life game. While one embodiment is directed towards a fantasy player competing against himself, another embodiment allows multiple fantasy players to play individually against himself/herself. In the embodiment where other fantasy players are playing, the other fantasy players may have the opportunity to select the same real life players in the same tiers in their fantasy game submissions.

The fantasy sport game may also give the option of selecting one actual player from more than one tier, although within each tier, only one player is selected as the “Best Performer” while the remaining players on the tier roster remain unselected. As an example, for Week #8 of an NFL season, a user may select available players on rosters for one or more of the quarterback tiers, the running back tiers, etc. Such selection may include one or more performance tiers, where the rosters include only those real life players that have established a threshold performance level by the time a selected game is played.

At step 310, the user submits the fantasy sports selections. Once the user has selected all the tier options for a game or season subset and submits the selections with the online fantasy sports game, the user may not be able to revise or change the selections. Also, the online fantasy sports game may prevent a user from making selections or changes to the selections after the a threshold time For example, if the first games in Week #3 are played on a Sunday afternoon, the user will be prevented from revising the selections made after the Friday of the current week, even if there are Week #3 games on Sunday night or Monday night.

At step 312, it is determined whether the user is a winner of the fantasy sports game based on his/her selections (e.g., performance in the related actual sports games). In one embodiment, it is determined whether the user has selected a real-life player, within at least one tier, whose actual performance in an actual game ranks that elected player as the “Best Performer” within the tier. The online fantasy sports game would determine a fantasy performance score for each actual game played. This score may be determined for a discrete game or season subset. For example, if during Week #5 of a regular NFL season, Joe Flacco is the “Best Performer” within the quarterback tier, any user that has selected Joe Flacco as the “Best Performer” within the quarterback tier may be eligible to win an award. If, for a season subset of AFC games, Tom Brady is the “Best Performer” in the quarterback tier, then any user that has selected Joe Flacco as the “Best Performer” would not win an award. Similarly, if during Week #5, the online fantasy sports game provides a tier of offensive players in the AFC and Joe Flacco is on the roster of players in that tier, any other offensive player may be the “Best Performer” within the tier and selection of Joe Flacco will not result in an award if an unselected player in the tier is determined to be the “Best Performer”. The determination of “Best Performer” may be calculated using a fantasy scoring formulation. Then, it would be determined if the user was a winner based on the selection(s) made by the user. In the situation where a user selects more than one selection (e.g., the user selects one player in each of several tiers of players), the online fantasy sports game may determine that each selection needs to be correct in order for the user to be considered a winner.

At step 314, the user is awarded with a lottery cash sum or other prize if it has been determined that the user is a winner based on his/her selection (s). It should be appreciated that the lottery cash sum may be many different types of awards, such as money, free future game plays, or other awards. In some embodiments, winning is based on or determined by comparing an individual real life player's best performance against the actual performance of other players within a roster of real life players that is made available for selection within a tier. If all of the tiers in each game (or some predetermined subset of games) is selected correctly, the user wins.

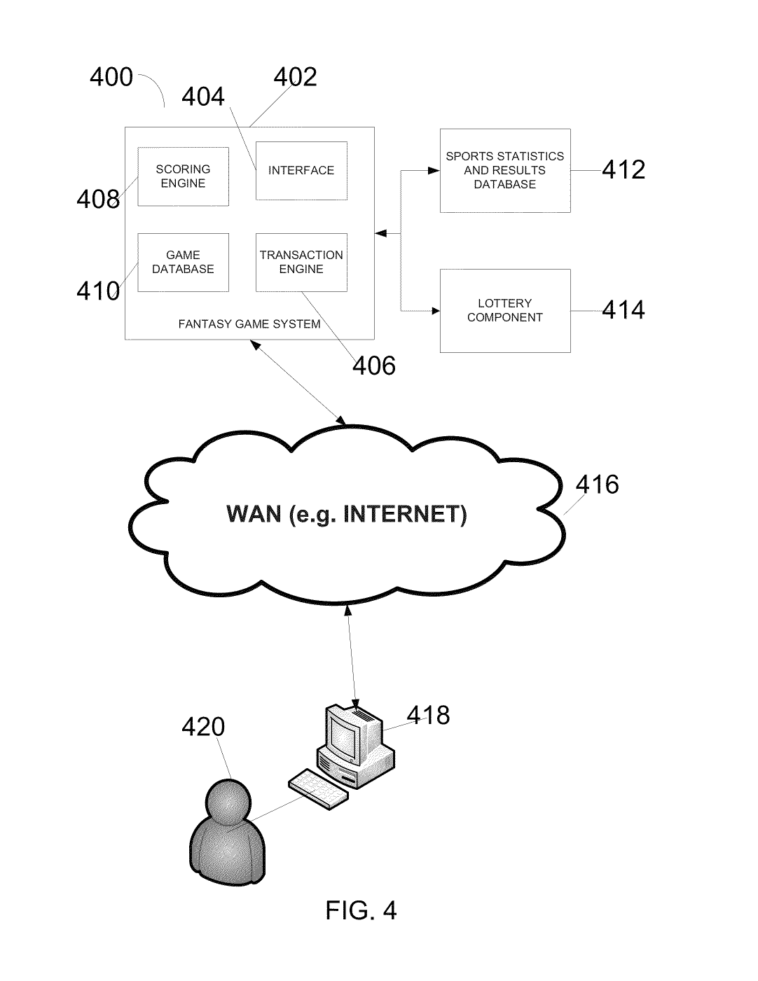

Now referring to FIG. 4, an exemplary system diagram for the system 400 is provided in accordance with the embodiments of the present invention. System 400 may include an online fantasy sports game system 402, a sports statistics and results database 412, a lottery component 414, a wide area network (WAN) 416, a user's computer 418, and a user 420. The online fantasy sports game system 402 may also include an interface 404, a transaction engine 406, a scoring engine 408, and a game database 410. The online fantasy sports game system 402 is not limited to only these components. The interface 404 may provide functionality that enables the system 402 to interact with the other components either within the fantasy sports game system 402 or outside of the fantasy sports game system 402. The interface 404 may also provide a user interface that the user would view when visiting the fantasy sports game website or mobile application.

The interface may be configured to permit access to a social networking system over the network. A user may access a collaborative social networking system via a log-in that may be immediately presented or may be accessible from another web page or from a mobile application. Users can indicate, and registered users can modify, the users' willingness to receive invitations to play the fantasy sports game. A collaborative social networking system may also support an application for users to exchange comments regarding “Best Performer” selections that can encourage users to play the game more often and to make selections within more tiers.

The transaction engine 406 may provide many different functionalities, such as facilitating financial transactions between the fantasy sports game system 402 and the user 420. For example, the user 420 may purchase a subscription or pay per use fee to make selections on the fantasy sports game website or mobile application. The transaction engine 406 may provide functionality to receive credit card information and/or other methods of payment (e.g. PayPal, wire transfer, etc.). Also, if the user is determined to be a winner after making and submitting selections on a fantasy sports game website or mobile application, the transaction engine 406 may provide functionality to provide the award to the user 420. For example, if the award is a cash prize, the transaction engine 406 may facilitate obtaining the user's 420 mailing address, or information for a direct deposit into a bank account, etc. If the award is not a cash prize, the transaction engine 406 may also help facilitate awarding the user 420 with the award in other ways.

The scoring engine 408 may provide functionality for determining a fantasy performance score for each game or player. The scoring engine 408 may be in communication with the sports statistics and results database 412 and the game database 410. The game database 410 may be used to store information pertaining to past, present and future games within the fantasy sports game system 402. The game database 410 may include user 420 information. The user 420 information may include, but is not limited to, past and present game submissions and results, financial information, personal preferences, etc. The sports statistics and results database 412 may include information pertaining to the actual real life sports games. The sports statistics and results database 412 may also receive and transmit data feed information pertaining to the relevant sports information. The scoring engine 408 may utilize information requested or received from the sports statistics and results database 412 to determine if a user is a winner, to create odds of a particular player, game, or team selection.

Determining the odds of a particular player, game, or team may influence the amount of the award that is awarded to user 420 in the situation that user 420 is a winner. The scoring engine 408 may also be in communication with the lottery component 414 to make these determinations about the odds. The scoring engine 408 may request information from the game database 410 to determine the accuracy of the user's selection(s). Once the scoring engine 408 makes the determination about whether user 420 is a winner, the scoring engine 408 may communicate this information to one or both of the interface 404 and the transaction engine 406.

The sports statistics and results database 412 may request or receive up-to-date (e.g., real-time or near real-time) information about relevant real life sports games. The lottery component 414 may provide functionality to facilitate communication between the fantasy sports game system 402 and a third-party lottery site or mobile application. The computer 418 and the fantasy sports game system 402 may be communicatively coupled to a WAN 416. For example, the WAN 416 could be the Internet. The WAN may include wired, wireless networks and interconnection. If desired, the WAN may be a private network. The sports statistics and results database 412 and the lottery component 414 may also be communicatively coupled to the WAN 416. The computer 418 may be any different types of computing devices, such as a personal computer, laptop, mobile device, tablet, etc.

Now referring to FIG. 5, a user may select “Best Performers” in one or more tiers through an appropriate such as exemplary selection page 500 from an embodiment of an online fantasy sports game website as disclosed herein. It should be appreciated that an online fantasy sports game website is not limited to the features and overall look illustrated in FIG. 5. Also, the online fantasy sports game may be implemented as a mobile application. Selection page 500 includes a graphical representation 502 of a selected sport in which players will be selected as “Best performers” from an available roster of players in a given tier. In the example shown in FIG. 5, a “Football Fantasy Challenge” is shown, although it is understood that any sport may be selected at selection page 500 (or any prior to subsequent selection page, not shown). Selection page 500 includes an identification 504 of the game or subset of games for which a user is selecting the “Best Performers” (e.g., as shown in FIG. 5, the selections are being made for Week #9 of a regular NFL season). An option 506 may be provided to review and/or research the matchups for the instant game.

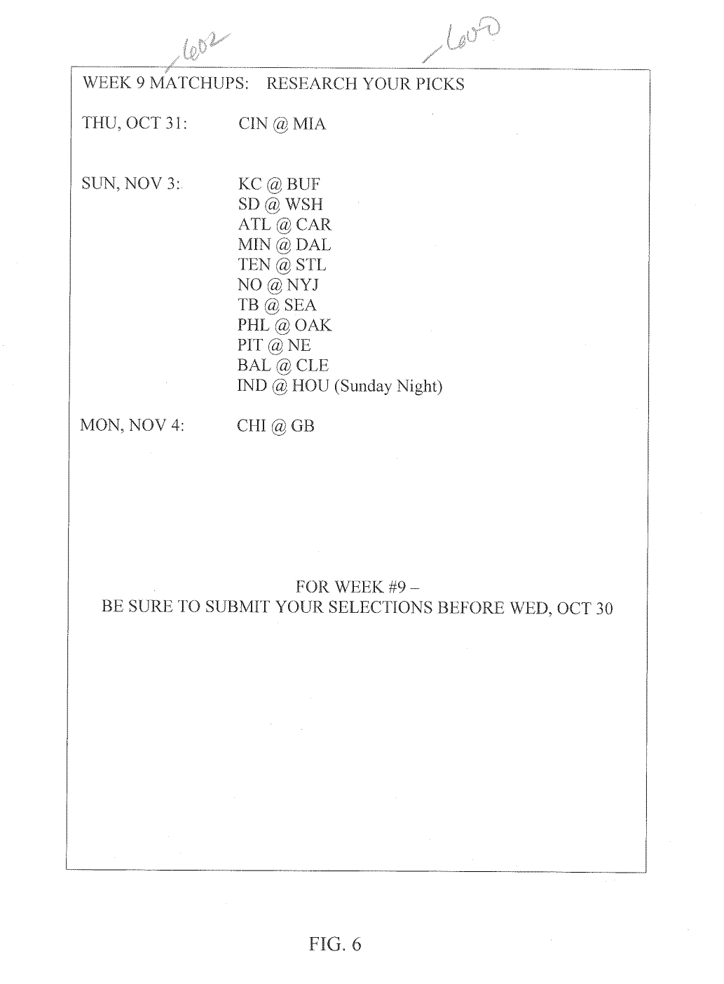

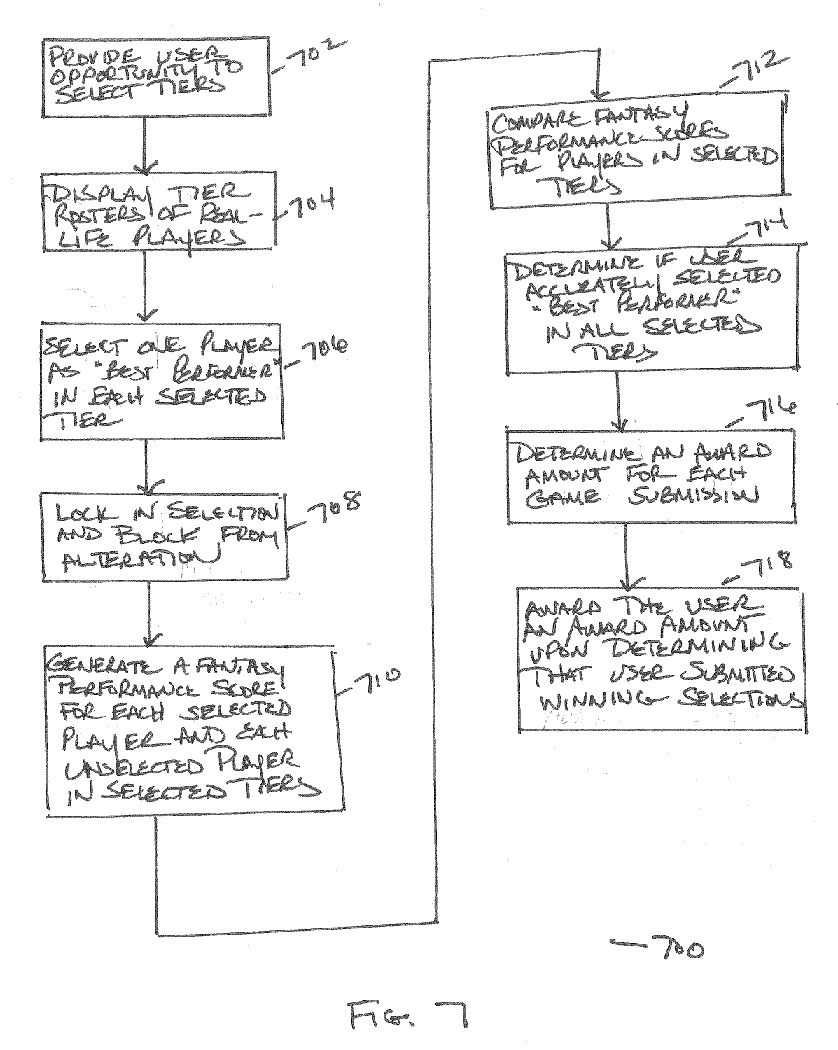

If a user wishes to research games for a common week in a regular season of American football, a user may selection option 506 on selection page 500 and access an exemplary game research page 600 as shown in FIG. 6. In the NFL example shown, game viewing page 600 may include a list 602 of all games being played in Week #9 and the dates on which those games are played. List 602 may identify Thursday night, Sunday night and Monday night games that would be considered as games within a common week of the American football season. Those games would therefore be considered by the fantasy sports game in determining the “Best Performer” in each tier for games played in Week #9. It is contemplated that game research page 600 may include statistical information, video streaming and other data and media relevant to the games being played in Week #9. A user may also be able to access video highlights and statistical information for a specific real-life player being considered for selection by the user as a “Best Performer” on game research page 600. For example, a user may wish to review plays made by a real-life player in prior games. A user may also want to review plays and statistics for players that have been identified by the fantasy sports game as the “Best Performer” for any prior week in the season, The user has the option of viewing all game dates and matchups for the common week in the American football season, along with any associated media, prior to making selections on selection page 500. It is understood that no selections are made on game research page 600.

Selection page 500 may include one or more graphical representations of tiers 508 (a quarterbacks tier), 510 (a wide receivers tier), 512 (a running backs tier), 514 (a special teams tier), 516 (a defensive players tier) and 518 (a tier incorporating players from a variety of positions as described above) that are available for selection of the “Best Performer” by the user. Selection of a particular tier may access player rosters for that tier, from which the user can predict the “Best Performer” for that tier, select the actual player predicted to be the “Best Performer” and leave the remaining players in that tier unselected. Selection of a particular tier may also access additional tiers for selection of “Best Performers” by the user. For example, selection of the “All In” tier represented by 518 may direct a user to one or more additional tiers in which multiple players from a variety of positions are provided for selection in each tier. One exemplary tier that may be accessed from 518 is a rookies tier that includes all rookie players, regardless of position. Another exemplary tier may be a tier of all “Best Performers” from a previous game that are playing in the instant week's game.

A set lineup menu option provided within each tier selection may provide a user with the ability to either view a potential lineup planned for a particular real life sports game or allow the user to select the “Best Performer” who will play in the selected tier. A standings and statistics option may provide information to the user pertaining to player and team rankings independent of the fantasy sports game. A live scoring option may provide the user with real-time or near real-time scores and statistics of the games being followed by the user. The live scoring menu option may further provide functionality to direct the user to a website to watch the game live. An IQ menu option may provide trivia or other valuable information about the players and teams. A scouting report menu option may provide the user with information about trades of players between teams, new players that may join the team in the future or injuries to current players. A rules menu option may provide rules information about the particular sport or rules information about how the fantasy sports game is played and scored.

The graphical representations may provide different functionalities. For example, after selecting a set lineup menu option, a graphical representation of players may be displayed. The graphical representation of players may illustrate to the user which players will be playing in a particular game and the players' positions for that particular game. The graphical representation of players may also illustrate which players are not playing in that particular game and for what reason (e.g., injury, illness, league sanction, etc.). It should be appreciated that when the sport, team, or players change, the positions, names and player pictures change accordingly. The listing of players may also be organized in any desired order (e.g., by starting players, in alphabetical order, etc.).

Upon selection of a “Best Performer” in each tier at selection page 500, the user submits such selection to the fantasy sports game system. The user can select the “Best Performer” in all available tiers or select the “Best Performer” only in selected tiers. In some embodiments, the user must have an accurate selection for all tiers in which a selection has been made in order to receive an award. In some embodiments, the user need only select one accurate selection to receive an award, although such award is scaled accordingly.

A multiplier selection may be provided through which the user indicates an elevated level of confidence in the user's selection of the “Best Performer” in each tier. Upon selection of a multiplier, the user, upon winning an award, will received an award amount that is increased by a factor of the multiplier (e.g., the award amount may be doubled, tripled, etc.).

Now referring to FIG. 7, an exemplary online fantasy sports game process 700 is shown. At step 702, a user is provided the opportunity to select one or more tiers (e.g., as shown with respect to FIG. 5). Selection of a tier reveals a roster of real life players established for that tier and playing in the upcoming game(s). At step 704, the user views the roster of players established within the selected tier and predicts the “Best Performer” for that tier out of the list of all players on the tier roster.

At step 706, the user submits the selection(s) of “Best Performer” for each tier as a lottery game submission. The user may submit several selections at step 706. For example, the user may submit selections for all available tiers. Alternatively, the user may submit selections more than one sports league at one time (e.g., selecting and submitting the “Best Performers” for NFL and NHL games on a given game day where teams in both leagues have scheduled game). Alternatively, the user may submit selections for different entities in the same league or series (e.g., the user can simultaneously submit the “Best Performers” for the drivers championship and the constructors championship established by driver and constructor performance at the Grand Prix of Monaco).

At step 708, the user is blocked after entering a selection of “Best Performers” (that is, the user's selections are “locked in”). The entered selections are used to determine a user's winning status irrespective of whether the selected player is injured, does not start or only plays a partial game. At step 708, a user is blocked from being able to select more than one real-life player as the “Best Performer” for the selected tier. In some embodiments, at step 710, if the same player is made available on more than one tier roster, the user who has selected that player as the “Best Performer” in one tier is blocked from selecting that same player as the “Best Performer” in another tier.

At step 710, a fantasy performance score is generated based on the performance, during a real life game, of each player within a tier. The fantasy performance score may be determined using a fantasy scoring formulation. The fantasy performance score may be calculated differently for different sports and/or leagues. Also, a fantasy performance score for a game may be calculated differently than for a player. This is not an exhaustive list but it should be appreciated that the information to determine how well a player played in a specific game may be multifaceted. For example, the fantasy performance score may be scored based on many different factors, such as total points scored, total rush yards, total throwing yards, total sacks, total interceptions, etc.

At step 712, fantasy performance scores for players within a particular tier are compared so that the “Best Performer” for that tier may be determined. At step 714, it is determined whether the user accurately selected the “Best Performer” within the tier. In some embodiments, the user can submit multiple selections about multiple players in one game submission, but only one “Best Performer” per tier can be selected and each of the selections must be correct in order for the user to win an award.

At step 716, an award amount is determined for each game submission. Each game submission may be treated differently. Some selections may have better odds than others. Therefore, the odds of winning based on the selections may also come into account to determine the amount of a possible award. At step 718, the user is awarded an award amount upon determining that the user selected each player in a game submission. At step 718, a notification may be generated that notifies one or more winners of corresponding lottery submissions when the users are identified by the computer system to have won the fantasy sports game. (e.g., send a message or signal, transfer cash, etc.).

When the software determines a lottery entry is a winner, a message comprising a message signal is transmitted to the lottery system to communicate the status and initiate the payment process.

If desired, the fantasy sports game can be implemented as part of casino online gaming sites. If desired, the game can be configured to provide options other than a comparison-based selection, such as providing options to make selections against a sports line or performance threshold in a game. The options can be implemented using software and hardware as illustratively described here. If desired, the application and system may be used for enhancing performance measurement for training performances of athletes and sports teams. If desired, the fantasy game can be configured to allow a user to select a group of games for each real life player and use a comparison to an unselected group of games to determine whether the player own or selected correctly. If desired, the game can be configured to allow a user to select a team or any portion of a team (e.g., offense, defense special teams, etc.).

In preferred embodiments, a new interactive feature and resource can be provided that implements a fantasy football based lottery system for public use. Software may be implemented that runs on computers, networks and storage media that provides member of the public to purchase a lottery entry that comprises the option to select a single player from list of real-life football players in a tier (e.g., a specific football position) and to select a second player from a second list of real-life players in second tier (e.g., a different football position). Similarly third, fourth, and fifth player selections can be made in third, fourth and fifth tiers. The set of selections in each tier can be saved in association with information for that lottery entry (e.g., as a number or a user ID). The tiers are also specifically for the upcoming games of the real-life players in that current week (or a future week) of a football season.

The software can implement security and storage features to protect the lottery entries and save the information for later assessment and retrieval. Public users can use the system and software to obtain multiple lottery entries. The system may also have software implemented that will provide a point of sale system that will permit public uses to submit a payment and purchase the lottery entry. The software may also have source of external data, such data representing fantasy points or individual fantasy point totals for individual real life players that are generated when the real-life players compete in a game during the current week (or a future week) after the public users have made their selections of which players will perform the best as compared to the other players in the same tier. in some embodiments, the list is limited to subsets of all players that are listed as active by a football league, or the list may include all players that are currently listed on the team's roster of players regardless of status (e.g., the roster of 45 active players for all teams). The subset can be, for example, 10-25 players.

In some embodiments, the software is implemented to determine which player among the players in the roster in each tier had a performance in the played game in that week that is the best compared to the other players in the list, not against all players in the league at that position. After the public user makes his or her selection and submits a lottery entry by pressing an acceptance button or option on a computer display screen, the lottery entry is securely saved, The software and system can also monitor and provide reports on the current number of lottery entries. When the games are played, or thereafter, data generated from the games can be processed using a point system to generate fantasy points for individual real-life player's performance. If desired, the software or system may receive point totals or representative information such that another system is performing the determination of the appropriate fantasy points for each player.

If desired, the software can be configured to allow individual public users to interact with the system to select and option that retrieves individual tottery entries and that also displays information providing the performance status or current total points of individual players on the list of the tiers. The display will be generated and will include information that the public users can view to monitor the state of their lottery entries as the games and individual players perform in their respective real-life games. The software can receive this data feed continuously from a data source that distributes game performance statistics or a source that distributes fantasy points for player performance. The software applies the data feed to the lottery entries and scores each entry to determine how many tiers a public user selected correctly.

If desired, the software can use an algorithm to simply score the winning entry or entries, if any, such as to figure which entries picked the correct five players in each tier (assuming a five player selection implementation). The software would be implemented to generate a display that informs public users of the score of their lottery entries (e.g., 2 out of 5 correct and identify scores for the listed players). The software would implement security components such as authentication to verify public users and to use it as a secure way to inform a winner of the winning lottery entry. The software can also include lottery system or software components and can communicate with a lottery system.

The software can be implemented on a server and may communicate with lottery system or client devices such as mobile devices or PCs over a computer network. A browser-based interface may be implemented by the software that permits public users to communicate with the servers using HTML, SHTML, JAVA, IFRAME, or other Internet protocols if desired. In a mobile implementation, a resident application can be implemented on the mobile device that generated a GUI for the fantasy game based on interaction with the server. Communication can for example be conducted using Mobile devices and iPhones or Android devices can use conventional communications to carry out and drive the GUI and the service. The server can include one or more servers and may use or include a database that is local or remote. A firewall or other security protection may also be implemented. The server may also communicate with lottery servers or equipment such as to communicate user or financial data. The software is implemented on this equipment and network (e.g., Internet, mobile network, private network) and when implemented provides the public users with a fantasy football game as a new enhancement in the set of available interactive game features available to users.

The online fantasy sports game system, computing devices, databases, or other discrete software or hardware components can communicate and are arranged to carry out the illustrative processes and applications described herein by way of sending a signal such as a packet, digital message, or a command within a communication to or between components (and act in response to the receipt of a signal to carry our processes) and between or through supporting software or hardware such as communicating with an operating system, communicating with another resident application through an API or the like, communicating between network elements using an Internet protocol or one or more layers of the OSI model, or communicating through an intermediate component.

The online fantasy sports game system may operate in coordination with application software running external to the computing device to carry out or provide the intended game experience. For example, the online fantasy sports website or mobile application may interact with another software to authenticate a user, check the status of a user's account, or carry out financial transactions. Providing software features that are subsidiary or are tangential to the game functionality can be incorporated into the online fantasy sports game system or can be provided in conjunction or coordination with other software if desired.

A computing device can include a computer, computer system or other programmable electronic device, including a client computer, a server computer, a portable computer (including a laptop and a tablet), a handheld computer, a mobile phone (including a smart phone), a gaming device, an embedded controller and any combination and/or equivalent thereof (including touchless devices). Moreover, the computing device may be implemented using one or more networked computers, e.g., in a cluster or other distributed computing system. It is understood that the exemplary environment discussed and illustrated is not intended to limit the present disclosure, and that other alternative hardware and/or software environments may be used without departing from the scope of this disclosure. The present techniques can be applied to devices other than hand-held devices, such as laptops or desktop computers.

Further, the terms “computing device”, “computer device”, “computer” and “machine” are understood to be interchangeable terms and shall be taken to include any collection of computing devices that individually or jointly execute a set (or multiple sets) of instructions to perform any one or more of the methods discussed herein.

The local storage can include volatile memory (such as RAM) and/or non-volatile memory (such as ROM as well as any supplemental levels of memory, including but not limited to cache memories, programmable or flash memories and read-only memories). The computing device or hand-held device can include one or more processing devices (e.g., one or more central processing units (CPUs), one or more graphics processing units (GPUs), one or more microprocessors OM and similar and complementary devices) and optional media devices (e.g., a hard disk module, an optical disk module, etc.). Additionally, any storage techniques used in connection with the presently disclosed method and/or system may invariably be a combination of hardware and software.

One or more features illustratively described herein can be implemented individually or in various combinations. The present system, method, or related inventions also relate to a non-transient computer readable medium. The application can be set of instructions readable by a processor and stored on the non-transient computer readable medium. Such medium may be permanent or semi-permanent memory, such as hard drive, floppy drive, optical disk, flash memory, ROM, EPROM, EEPROM, etc., as would be known to those of ordinary skill in the art.

Features or characteristics described in one context, process, or device are applicable to other context, process or devices described herein, The steps of the processes illustratively described herein can be performed in a different order, if desired. Also, steps could be added or removed from the processes illustratively described herein. The processes or steps illustratively described herein can be implemented in software and data (in computer readable medium, transient and/or non-transient) using the described examples of hardware and network configurations.

The verb “may” is construed to mean that, although this is one way of practicing the presently disclosed invention, it is not limited to that example.

The terms and expressions which have been employed in the specification are used as terms of description and not of limitations, there is no intention in the use of such terms and expressions to exclude any equivalents of the features shown and described or portions thereof, but it is recognized that various modifications are possible within the scope of the claims to the invention.

What is claimed is:

1. A method enabling a user to play an online fantasy sports game over a network-connected device, comprising:
on the network-connected device, presenting to the user an opportunity to play the online fantasy sports game when the user lands on a lottery site;
in response to a user selection to play the fantasy sports game on the lottery site, directing the user to the online fantasy sports game;
in response to the selection to play the fantasy sports game, providing, to the user, a plurality of fantasy sports selection options for playing the fantasy sports game, with the plurality of fantasy sports selection options including at least one option to select one or more tiers with each selected tier including a roster of real-life players established within the selected tier, and at least one option to select, within each selected tier, a real-life player predicted by the user to have a real-life performance superior to other players within the selected tier during at least one upcoming game of American football, wherein the real-life players are listed for selection in association with the individual real-life players' upcoming game in a common week of a football season;
receiving, from the user, one or more fantasy sports selections that completes a lottery submission before the upcoming game begins, with each fantasy sports selection including at least one selected tier and a player selected within the selected tier, with the user submitting multiple fantasy sports selections from multiple tiers;
generating, on a computer system and from a data feed of game activity, a fantasy performance score for each selected player and for each unselected player within each selected tier;
comparing, on the computer system, the fantasy performance score for each selected player and each unselected player within each tier;
determining, on the computer system, a highest fantasy performance score attributable to each player within the selected tier;
determining, on a computer system, which users have won the online fantasy sports game based on each user's selections and each of the determined corresponding fantasy performance scores, which includes determining the user is a winner when each of the user's multiple selections matches the highest fantasy performance score attributable to the selected real-life player within the selected tier; and
generating a notification that notifies one or more winners of corresponding lottery submissions when one or more users are identified by the computer system to have won the fantasy sports game.

2. The method of claim 1, further comprising blocking a user from altering the lottery submission after receiving, from the user, the fantasy sports selections.

3. The method of claim 2, wherein blocking the user includes at least one of preventing the user from selecting more than one real-life player within any selected tier, and preventing the user from selecting any real-life player in more than one tier.

4. The method of claim 1, wherein the one or more related actual sports games includes professional football teams, semi-professional football teams and college football teams.

5. The method of claim 1, further comprising determining, on the computer system, an award amount for each game submission.

6. The method of claim 5, further comprising providing a multiplier selection that, when selected and the user is a winner, increases an award to the user.

7. The method of claim 1, wherein at least one of the online fantasy sports game and the lottery site is a mobile application.

8. A method enabling a user to play an online fantasy sports game on a network-connected device, comprising:
providing a display on the network-connected device;
displaying at least one tier of real-life players established within the selected tier as participating in at least one upcoming real life sporting event;
enabling a user to make a selection to play the fantasy sports game;
providing, to the user, a plurality of fantasy sports selection options for playing the fantasy sports game, with the plurality of fantasy sports selection options including at least one option to select one or more tiers with each selected tier including a roster of real-life players established within the selected tier, and at least one option to select, within each selected tier, a real-life player predicted by the user to have a real-life performance superior to other players within the selected tier superior to other players within the selected tier during at least one upcoming game of American football, wherein the real-life players are listed for selection in association with the individual real-life players' upcoming game in a common week of a football season;
receiving, by a computer system, one or more fantasy sports selections that completes a lottery submission before the upcoming game, with each fantasy sports selection including at least one selected tier and a player selected within the selected tier, with the user submitting multiple fantasy sports selections from multiple tiers;
generating, on the computer system using data feeds of game activity, a fantasy performance score for each real life player corresponding to a roster of players within each selected tier using a fantasy scoring formulation;
determining, on the computer system, a highest fantasy performance score attributable to each player within the selected tier;
comparing, on the computer system, the fantasy performance score for each selected player and each unselected player within each tier;
determining, on the computer system, which users have won the online fantasy sports game based on each user's selections and each of the determined corresponding fantasy performance scores, which includes determining the user is a winner when each of the user's multiple selections matches the highest fantasy performance score attributable to the selected real-life player within the selected tier; and
generating a notification that notifies one or more winners of corresponding lottery submissions when one or more users are identified by the computer system to have won the fantasy sports game.

9. The method of claim 8, further comprising blocking a user from altering the lottery submission after receiving, from the user, the fantasy sports selections.

10. The method of claim 9, wherein blocking the user includes at least one of preventing the user from selecting more than one real-life player within any selected tier, and preventing the user from selecting any real-life player in more than one tier.

11. The method of claim 8, wherein the one or more related actual sports games includes professional football teams, semi-professional football teams and college football teams.

12. The method of claim 8, further comprising determining, on the computer system, an award amount for each game submission.

13. The method of claim 12, further comprising providing a multiplier selection that, when selected and the user is a winner, increases an award to the user.

14. The method of claim 8, wherein at least one of the online fantasy sports game and the lottery site is a mobile application.

15. A system for enabling a user to play an online fantasy sports game system on a network-connected device, comprising:
at least one server configured to perform actions comprising:
accessing the system over a network; and
performing the method of claim 1.

16. A non-transitory computer-readable media comprising a plurality of instructions that, when executed, cause a network-connected device to perform the method of claim 1.

17. A system for enabling a user to play an online fantasy sports game system on a network-connected device, comprising:
at least one server configured to perform actions comprising:
accessing the system over a network; and
performing the method of claim 8.

18. A non-transitory computer-readable media comprising a plurality of instructions that, when executed, cause a network-connected device to perform the method of claim 8.
